(19) United States
(12) Patent Application Publication
(10) Pub. No.: US 2025/0271042 A1
(43) Pub. Date: Aug. 28, 2025

(54) BRAKE ACTUATOR FOR A FRICTION BRAKE, FRICTION BRAKE AND VEHICLE

(71) Applicant: Robert Bosch GmbH, Stuttgart (DE)

(72) Inventor: Matthias Greiner, Simmozheim (DE)

(21) Appl. No.: 19/062,094

(22) Filed: Feb. 25, 2025

(30) Foreign Application Priority Data
Feb. 27, 2024 (DE) 10 2024 201 761.2

(51) Int. Cl. F16D 65/18; F16D 125/20; F16D 125/58

(52) U.S. Cl. CPC F16D 65/18; F16D 2125/20; F16D 2125/587

(57) ABSTRACT

A brake actuator for a friction brake. The brake actuator includes a piston and a rotational-to-translational gearbox for converting a rotary motion of a drive into a linear motion of the piston. An angle compensation element for decoupling the translational component from transverse forces on the piston is arranged between a translational component of the gearbox and the piston.

### CROSS REFERENCE

The present application claims the benefit under 35 U.S.C. § 119 of German Patent Application No. DE 10 2024 201 761.2 filed on Feb. 27, 2024, which is expressly incorporated herein in its entirety.

### FIELD

The present invention relates to a brake actuator for a friction brake, to a friction brake with such a brake actuator, and to a vehicle with at least one such friction brake.

### BACKGROUND INFORMATION

A brake actuator of a friction brake can generate a required contact force for generating friction between brake pads and a rotor of the friction brake. The brake actuator can, for example, be electromechanical. An electric motor generates a rotary motion, which is converted into a linear motion via a rotational-to-translational gearbox. The linear motion is then transmitted to at least one brake pad.

Since brake pad brackets require some play to allow the linear motion of the brake pad, the brake pad moves in the same direction as the rotor during braking until it is held in place by the brackets. This motion is carried out transversely to the linear motion and is also transmitted to the rotational-to-translational gearbox.

### SUMMARY

The approach presented here according to the present invention presents a brake actuator for a friction brake, a friction brake with such a brake actuator, and a vehicle with at least one such friction brake. Advantageous developments and improvements of the approach presented here emerge from the description herein and rest of the disclosure herein.

With the approach presented here according to the present invention, a rotational-to-translational gearbox of a brake actuator, for example a ball screw drive or a threaded drive, is decoupled from the effects of lateral forces by an additional decoupling element.

Here, angular mobility between the gearbox and a piston acting on a brake pad is ensured by an angle compensation element. As a result, the piston can tilt slightly sideways when subjected to lateral forces, without this tilting motion being transmitted to the gearbox. However, there is still a direct coupling in the axial direction of the gearbox.

The approach presented here according to the present invention makes it possible to dimension the gearbox only for axial loads, since no lateral loads are introduced into the gearbox due to the angle compensation element. The gearbox can thus be manufactured cost-effectively since no oversizing is required.

According to an example embodiment of the present invention, a brake actuator for a friction brake is provided, wherein the brake actuator comprises a piston and a rotational-to-translational gearbox for converting a rotary motion of a drive into a linear motion of the piston, wherein an angle compensation element for decoupling the translational component from transverse forces on the piston is arranged between a translational component of the gearbox and the piston.

Furthermore, according to an example embodiment of the present invention, a friction brake for a vehicle is provided, wherein the friction brake comprises a rotor, a brake clamp and a brake actuator according to the approach presented here, wherein a movable brake pad of the friction brake is arranged between the brake actuator and one side of the rotor and a fixed brake pad of the friction brake is arranged between the brake clamp and an opposite side of the rotor, wherein the angle compensation element arranged between the translational component of the gearbox and the piston is configured to decouple the translational component from transverse forces on the piston.

Furthermore, according to an example embodiment of the present invention, a vehicle with at least one friction brake according to the approach presented here is provided.

Ideas for embodiments of the present invention may be considered, inter alia, as being based on the concepts and findings described below.

A brake actuator can be an electromechanical brake actuator and abbreviated as EMB. The brake actuator can be arranged on a brake caliper or a brake clamp of a disk brake. The brake actuator comprises an electric drive motor, a rotational-to-translational gearbox and a piston mounted in the brake caliper. The piston presses on the back of a brake pad of the disk brake, analogously to a hydraulic brake. The brake pad is movably mounted in the brake caliper by a guide. A counterforce to the contact pressure of the piston is supported via the rotational-to-translational gearbox on the brake caliper and transmitted to an opposite brake pad of the disk brake. As a result, the brake disk is clamped between the brake pads and, for generating friction, the brake pads are pressed against the opposite friction surfaces of the brake disk with approximately the same force.

If friction generates a braking force, a counterforce to the braking force is supported via the guide of the brake pads. Until the counterforce is completely supported, the brake pads move transversely to the contact force. As a result, a lateral force acts on the piston during braking.

The lateral force causes a slight tilting of the piston in the brake caliper. With the approach presented here, the angle compensation element decouples the rotational-to-translational gearbox from this tilting.

According to an example embodiment of the present invention, the angle compensation element can be formed as a type of ball joint. At least a partial region of a spherical shell can be formed on a part of the angle compensation element. Another part of the angle compensation element can be supported in the spherical shell in an angularly movable manner. Alternatively or additionally, at least a partial region of a spherical surface can be formed on a part of the angle compensation element. The spherical surface can be supported on another part of the angle compensation element in an angularly movable manner. A spherical shell can be concave. A spherical surface can be convex. A spherical shell and/or spherical surface is particularly well suited to transmit high compressive forces at variable angles. If the spherical shell and the spherical surface fit together, there is a low surface pressure despite a high contact force. Rolling elements can be arranged between the spherical shell and the spherical surface and rest on the spherical shell or spherical surface. The rolling elements can be balls or rollers, for example. Balls can have a point contact with the spherical shell or spherical surface. Rollers can have a line contact with the spherical shell or spherical surface. Then, the angle compensation element can be designed as a rolling bearing with low friction.

According to an example embodiment of the present invention, the part of the angle compensation element with the spherical surface can be connected to the translational component of the gearbox. A spherical surface can be formed particularly easily on the translational component, for example by turning. The spherical surface can be integrally connected to the translational component via a stem.

The spherical surface can be at least a hemisphere. The spherical surface can also be a three-quarter sphere, for example. The spherical surface can rest laterally on the other part of the angle compensation element and be guided laterally on the other part. The spherical surface can have at least one line contact with the other part. Alternatively, the spherical surface can have a circumferential groove. A spring ring can be arranged in the groove and is kept under tension by the other part. Due to the spring ring, the spherical surface can be locked into the other part.

The part with the spherical surface can be pressed into the other part. Due to the pressing of the spherical surface into an undersized recess, i.e., a press fit, the angle compensation element can transmit tensile forces and actively retract the piston.

According to an example embodiment of the present invention, the angle compensation element can also be formed to compensate for lateral position errors. For example, a spring ring can be arranged in a deep circumferential groove. The spring ring can have lateral play in the groove. Due to relative motion of the spring ring to the spherical surface, position errors can be compensated in addition to angular errors.

The angle compensation element can comprise a sliding piece. The sliding piece can be supported on a radial sliding surface of the piston. The sliding piece can in particular form the spherical shell. The sliding piece can slide sideways on the sliding surface for compensating for position errors.

At least one sliding ring can be arranged between the piston and a cylinder wall of the brake actuator. Since the brake actuator functions without hydraulic fluid, piston seals can be dispensed with. In a hydraulic brake, the piston seals serve not only to seal the piston but also to guide the piston axially. A sliding ring can be made of a more abrasion-resistant material than a seal and incur lower costs. The sliding ring can, for example, be made of a plastics material. The sliding ring can, for example, be arranged at the level of one end of the rotational component. The piston can then tilt in the sliding ring, thereby shielding the translational component from lateral loads.

A position compensation element for decoupling the piston from transverse forces on the brake pad can be arranged between the piston and the brake pad of the friction brake. A position compensation element can make lateral displacements between the brake pad and the piston possible within a predefined displacement range. In a simple design, the position compensation element can be a sliding bearing. The position compensation element can at least substantially prevent the lateral displacement of the brake pad from being transmitted to the piston during braking. Due to the lateral freedom of motion of the brake pad, the tilting of the piston is reduced. The piston can then substantially only be tilted by one-sided wear of the brake pad and/or tilting of the brake pad.

The position compensation element can be formed as an axial bearing with lateral tolerance. The position compensation element can substantially be formed to transmit axial forces. In particular, lateral forces and/or axial torques cannot be transmitted.

According to an example embodiment of the present invention, the position compensation element can be formed as a rolling bearing. The position compensation element can comprise rolling bodies arranged between two running surfaces. The rolling bodies can have a point contact or line contact with at least one of the running surfaces. The rolling bearing can be a bearing for a rotary motion and comprise rolling bodies arranged in a circle. Alternatively, the rolling bearing can also be a linear bearing and comprise rolling bodies arranged in rows. The rows can be aligned with an expected direction of motion of the brake pad.

The roller bearing can be formed as a needle bearing or a roller bearing. Needles or rollers can comprise an enlarged contact surface with the running surfaces via a line contact. Due to the large contact surface, a low surface pressure of the running surfaces and rolling bodies can be achieved. Due to the large contact surface, the rolling bearing can tolerate tilting, i.e., asymmetrical loading, without damaging the needles or rollers. The rolling bodies on one side of the rolling bearing can be subjected to greater loads than the rolling bodies on an opposite side of the rolling bearing.

The rolling bearing can be formed as a self-aligning bearing. The rolling bearing can comprise spherical shell-shaped or curved running surfaces, at least in some regions. As a self-aligning bearing, the rolling bearing can compensate for angular tolerances, while the rolling bodies of the rolling bearing are evenly loaded.

The rolling bearing can comprise a two-part shell. Tensile forces can be transmitted via the shell. A shell can consist of nested sealing shells. The sealing shells can form a labyrinth seal. Due to the nesting, the resulting tensile forces upon retraction of the brake pad can be transmitted from the piston to the brake pad.

It is pointed out that some of the possible features and advantages of the present invention are described herein with reference to different example embodiments. A person skilled in the art will recognize that the features can be suitably combined, adapted, or replaced in order to arrive at further embodiments of the present invention.

### BRIEF DESCRIPTION OF THE DRAWINGS

Embodiments of the present invention are described below with reference to the FIGURES, and neither the FIGURES nor the description should be construed as limiting the present invention.

FIG. 1 is a detailed sectional view of a brake actuator according to an exemplary embodiment of the present invention. The FIGURE is merely schematic and not true to scale. Identical reference signs refer to identical or identically acting features.

### DETAILED DESCRIPTION OF EXAMPLE EMBODIMENTS

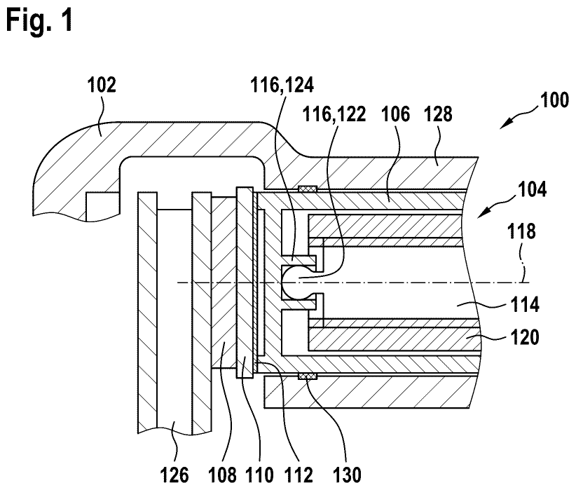

FIG. 1 is a detailed sectional view of a brake actuator 100 according to an exemplary embodiment. The brake actuator 100 is integrated into a brake clamp 102 of a disk brake. The brake actuator 100 comprises a drive, a rotational-to-translational gearbox 104 and a piston 106. The piston acts on a brake pad 108 of the disk brake. For example, the piston 106 presses on a back plate 110 of the brake pad 108, wherein an intermediate plate 112 is arranged between the back plate 110 and the piston 106.

Here, an angle compensation element 116 is arranged between a translational component 114 of the gearbox 104 and the piston 106. The angle compensation element 116 makes angular mobility between the piston 106 and the translational component 114 possible. As a result, tilting of the piston 106 from a rotation axis 118 of a rotational component 120 of the gearbox 104 is not transmitted to the translational component 114 when transverse forces act on the piston 106 during braking.

In one exemplary embodiment of the present invention, the angle compensation element 116 is designed as a type of ball joint. At least one side of the angle compensation element 116 has a positive or negative spherical shape, at least in some regions. Here, a ball 122 is formed on the translational component 114 and is arranged in a receptacle 124 of the piston 106.

In one exemplary embodiment of the present invention, the ball 122 is pressed into the receptacle 124. The receptacle 124 is thus undersized in comparison to the ball 122. As a result, the ball 122 does not jump out of the receptacle 120 even when small tensile forces are transmitted, such as when the brake pad 108 is retracted from the brake disk 126.

In one exemplary embodiment of the present invention, the receptacle 124 also has a spherical shape in a partial region. The spherical shape is arranged in particular in the region of a penetration point of the rotation axis 118. This results in an enlarged contact surface between the ball 122 and the receptacle 124. The enlarged contact surface results in a reduced surface pressure on the ball 122 and the receptacle 124 during braking.

In one exemplary embodiment of the present invention, the ball 122 has a circumferential line contact with the receptacle 124. Due to the line contact, the ball 122 is guided laterally in all directions perpendicular to the rotation axis 118.

In one exemplary embodiment of the present invention, at least one sliding ring 130 is arranged between the piston 106 and a main body 128 of the brake clamp 102. The sliding ring 130 is arranged in a groove in a cylinder surface of a piston bore of the main body 128 and protrudes slightly beyond the cylinder surface. As a result, there is a small gap between the cylinder surface and a lateral surface of the piston 106 and the piston 106 does not touch the main body 128.

In one exemplary embodiment, the sliding ring 130 is arranged in the region of the angle compensation element 116. As a result, the piston 106 can tilt in the sliding ring 130 without laterally deflecting the translational component 114.

In one exemplary embodiment, the sliding ring 130 is made of a plastics material. As a result, the sliding ring 130 has good sliding properties on the lateral surface. The plastics material is in particular harder than sealing material of sealing rings, such as those used in hydraulic brakes.

Possible embodiments of the present invention are summarized again below or described using slightly different words.

A mechanism for generating axial force for electromechanical brakes is presented.

In an electrohydraulic brake, the rotation of a motor can be converted into a translational motion of a piston in order to generate hydraulic pressure with the aid of a planetary gear and a ball screw drive. The piston can be guided in a piston guide of a valve housing. In addition, seals can help guide and center the piston in the valve housing. The ball screw drive can be rigidly coupled to the piston, which is guided in the valve housing without any angular freedom. This means that the accuracy of the ball screw spindle in linear motion must be so good that the piston does not experience excessive wear within its guide in the valve housing over its service life. This may require expensive coating of the valve housing (partial anodizing).

In an electromechanical brake (EMB), a large lateral force acts on the piston via the brake pads, and the hydraulic pressure that helps to center the piston in its guide is not present. A robust rotation-to-translation mechanism for an EMB is therefore presented here. The piston is connected to the ball screw spindle via a radially flexible connection in a spherical shape. In this way, the accuracy of the ball screw drive for linear motion can be reduced in comparison to the current design. This results in a cost-effective ball screw design with low component costs. The grinding of parts can be avoided.

The guiding of the piston is additionally carried out by a plastics ring, which is mounted in the piston housing. A complex coating of the piston housing (e.g., anodizing) for preventing excessive wear over the service life can be avoided.

The flexible connection is achieved by the spherical design of the inner part of the ball screw spindle, which is fastened to the piston with a press fit that allows radial angle compensation between the motion of the piston and the motion of the ball screw spindle. With this design, there is no play in the direction of the piston axis for the linear motion of the piston, but a deviation from the axial motion of the ball screw spindle and its fixation in the piston housing can be compensated, which deviation does not follow the piston motion in its guide via the plastics ring in the piston housing.

In this way, the press fit together with the ball design can compensate for axis misalignments between the motion of the piston and the motion of the ball screw spindle. However, the axial connection of the ball screw spindle with the piston, in particular during the backward motion of the piston, is ensured by the detailed design of the press fit with the line contact of the ball with the press-fit geometry of the piston.

Summary of axial force flow: The piston presses the brake pad against the brake disk via the intermediate disk on the back plate.

The proposed design of the present invention provides a robust and cost-effective solution since the partial anodizing of the piston housing is avoided as a result of the plastics ring and the use of the cost-effective (non-ground) components of the ball screw drive.

Finally, it should be pointed out that terms like “having,” “comprising,” etc. do not exclude other elements or steps and terms like “a” or “an” do not exclude a plurality.

What is claimed is:

1. A brake actuator for a friction brake, the brake actuator comprising:
a piston;
a rotational-to-translational gearbox configured to convert a rotary motion of a drive into a linear motion of the piston, the gearbox including a translational component; and
an angle compensation element configured to decouple the translational component from transverse forces on the piston, the angle compensation element being arranged between the translational component of the gearbox and the piston.

2. The brake actuator according to claim 1, wherein the angle compensation element is a type of ball joint, wherein at least a partial region of a spherical shell is formed on a part of the angle compensation element and another part of the angle compensation element is supported in the spherical shell in an angularly movable manner.

3. The brake actuator according to claim 1, wherein the angle compensation element is a type of ball joint, wherein at least a partial region of a spherical surface is formed on a part of the angle compensation element and the spherical surface is supported on another part of the angle compensation element in an angularly movable manner.

4. The brake actuator according to claim 3, wherein the part with the spherical surface is connected to the translational component.

5. The brake actuator according to claim 3, wherein the spherical surface is at least a hemisphere, wherein the spherical surface rests laterally on the other part and is laterally guided on the other part.

6. The brake actuator according to claim 5, wherein the part with the spherical surface is pressed into the other part.

7. The brake actuator according to claim 1, wherein the angle compensation element is further formed to compensate for lateral position errors.

8. The brake actuator according to claim 7, wherein the angle compensation element includes a sliding piece, which is supported on a radial sliding surface of the piston.

9. The brake actuator according to claim 1, wherein at least one sliding ring is arranged between the piston and a cylinder wall of the brake actuator.

10. The brake actuator according to claim 1, wherein a position compensation element configured to decouple the piston from transverse forces on a brake pad of the friction brake is arranged between the piston and the brake pad of the friction brake.

11. The brake actuator according to claim 10, wherein the position compensation element is formed as an axial bearing with lateral tolerance.

12. The brake actuator according to claim 11, wherein the position compensation element is a rolling bearing.

13. A friction brake for a vehicle, the friction brake comprising:
a rotor;
a brake clamp; and
a brake actuator including:
a piston,
a rotational-to-translational gearbox configured to convert a rotary motion of a drive into a linear motion of the piston, the gearbox including a translational component, and
an angle compensation element;
wherein a movable brake pad of the friction brake is arranged between the brake actuator and one side of the rotor and a fixed brake pad of the friction brake is arranged between the brake clamp and an opposite side of the rotor, wherein the angle compensation element arranged between the translational component of the gearbox and the piston is configured to decouple the translational component from transverse forces on the piston.

14. A vehicle comprising at least one friction brake, the frictional brake including:
a rotor;
a brake clamp; and
a brake actuator including:
a piston,
a rotational-to-translational gearbox configured to convert a rotary motion of a drive into a linear motion of the piston, the gearbox including a translational component, and
an angle compensation element;
wherein a movable brake pad of the friction brake is arranged between the brake actuator and one side of the rotor and a fixed brake pad of the friction brake is arranged between the brake clamp and an opposite side of the rotor, wherein the angle compensation element arranged between the translational component of the gearbox and the piston is configured to decouple the translational component from transverse forces on the piston.
